(19) United States
(12) Patent Application Publication
(10) Pub. No.: US 2008/0211321 A1
(43) Pub. Date: Sep. 4, 2008

(54) Power adapter module with rotatable plug, power supply and electric apparatus with power adapter module or power supply of the same

(75) Inventor: Lai-Chieh Liao, Xindian City (TW)

Correspondence Address: SINORICA, LLC, 528 FALLSGROVE DRIVE, ROCKVILLE, MD, 20850, US

(73) Assignee: Billion Electric Co., Ltd.

(21) Appl. No.: 11/727,367

(22) Filed: Mar. 26, 2007

(30) Foreign Application Priority Data
Mar. 2, 2007 (TW) 96203461

(51) Int. Cl. H02M 1/00

(52) U.S. Cl. 307/151

(57) ABSTRACT

A power adapter module with alternative plug includes a power supply body constructed by putting an upper housing and a lower housing together, and an attachable/detachable plug, wherein a recess portion is formed within the upper housing. The recess portion includes a recess bottom and a recess wall, wherein a plurality of projecting hold portions are formed on a portion of the recess wall facing a center axial of the recess portion, and a plurality of recesses corresponding to the plurality of hold portions are formed on a plug wall of the plug adjacent to the recess wall. A groove thinner than other portions is formed on a portion of the hold portion near the recess bottom, and, in each recesses of the plug wall, a plug groove complementary to the groove is formed.

### FIELD OF THE INVENTION

The present invention relates to a power adapter module, a power supply, a portable electric device, and a travel power adapter, and more particular to a power adapter module, a power supply, a portable electric device, and a travel power adapter allowed to be alternated between plugs of different specifications and types.

### BACKGROUND OF THE INVENTION

Due to different power voltages supplied in different countries, it is inconvenient to bring electric appliances for use when travelling in different countries. Accordingly, a power supply that can be switched between different voltages is developed for travelers, so that the voltage provided in the arrived country may be adjusted to one being appropriate for the operation of the electric appliances from other countries.

The above-mentioned power supply can effectively solve the problem of the suitability of the voltage for the appliances. However, due to safety consideration, the types of receptacles in different countries are designed differently for distinguishing between different outlet voltages. Accordingly, the user cannot insert the plug of an appliance into a receptacle that supplies a voltage incompatible with the appliance, and thus preventing the appliance from getting damaged or other accidents from occurring. As a result, it gives rise to a new problem in that an appliance cannot be used in countries that use receptacles that cannot match its plug, even if the voltage provided therein is compatible. For solving such a problem, an attachable/detachable plug of the power supply is developed for being adapted to receptacles of various types. However, when unplugging such an attachable/detachable plug from a receptacle, the exerted force may be concentrated on the attachable/detachable plug, which may cause the attachable/detachable plug to become deformed, torn, or even broken, or separated from the power supply accidentally.

Therefore, it is desired to develop a simple and secure way to assemble the attachable/detachable plug on the power supply shell of the power adapter module.

### SUMMARY OF THE INVENTION

For solving the above-mentioned problems of the prior arts, the present invention provides a power adapter module with alternative plug and its various applications. The power adapter module includes a power supply body constructed by putting together an upper housing and a lower housing, a rectification/transformation circuit installed within the power supply body, and an attachable/detachable plug. A recess portion is formed within the upper housing for receiving and fixing a plug base of the attachable/detachable plug, and a portion of the circuit extends into the recess portion for being electrically connected to a terminal of the attachable/detachable plug fixed on the plug base. Wherein, the recess portion includes a recess bottom and a recess wall, and a plurality of projecting hold portions are formed on a portion of the recess wall facing a center axial of the recess portion. And, a plurality of recesses corresponding to the plurality of hold portions are formed on a plug wall of the plug adjacent to the recess wall for placing the plurality of hold portions. Furthermore, a groove thinner than other portions is formed on a portion of the hold portion near the recess bottom. And in each of the recesses of the plug wall, a plug groove complementary to the groove is formed. Accordingly, when the attachable/detachable plug is pressed into the recess portion, the plug groove is allowed to be rotated in a horizontal direction and pushed into the groove for being fixed within the recess portion of the power supply body.

Therefore, the primary object of the present invention is to provide a durable power adapter module with an alternative plug.

Another object of the present invention is to provide a power adapter module with an alternative plug for providing stable electrical connection.

A still another object of the present invention is to provide a durable power supply with an alternative plug.

A yet another object of the present invention is to provide a power supply with an alternative plug for providing stable electrical connection.

A further object of the present invention is to provide a durable portable device having a power adapter module with an alternative plug.

A still further object of the present invention is to provide a portable electric device having a power adapter module with an alternative plug for providing stable electrical connection.

A yet further object of the present invention is to provide a durable travel power adapter having a power adapter module.

A still further object of the present invention is to provide a travel power adapter having a power adapter module for providing stable electrical connection.

### DETAILED DESCRIPTIONS OF THE INVENTION

The present invention discloses a power adapter module with an alternative plug, which includes digital electric equipments having power adapter modules. The digital electric equipments are selected from a portable Global Positioning System (GPS), a portable computer, a digital multi-media broadcasting device, an electronic game console, an electronic storage and display medium, a mobile communication equipment, a mobile GPS, a mobile karaoke system, an image phone, a hand-held data processor, a transformer, an Asymmetric Digital Subscriber Line (ADSL) modem, a router, a power supply, a portable electric device, a travel power adapter, a home electric appliance, etc. . . The basic principle of the power adapter module and the basic structure of any one of the above-mentioned devices are known by those skilled in the art and will not be described in details here. Furthermore, it is acknowledged in advanced that the drawings referring to the following descriptions are only schematic illustrations related to the characterizations of the present invention, and the contents of these drawings are not drawn according to practical scales.

FIGS. 1 and 2, illustrating a first embodiment of the present invention, are exploded views of a power adapter module with an alternative plug. As shown in the drawings, the power adapter module 1 with an alternative plug includes a power supply body 12 constructed by putting together an upper housing 10 and a lower housing 11, a rectification/transformation circuit (not shown) installed within the power supply body 12; and an attachable/detachable plug 13. A recess portion 14 is formed within the upper housing 10 for receiving and fixing a plug base 131 of the attachable/detachable plug 13. A portion of the circuit extends into the recess portion 14 for being electrically connected to a terminal (not shown) 132 of the attachable/detachable plug 13 fixed on the plug base 131. It is characterized in that the recess portion 14 includes a recess bottom 141 and a recess wall 142, wherein a plurality of projecting hold portions 143 are formed on a portion of the recess wall 142 facing a center axial of the recess portion 14, and a plurality of recesses 134 corresponding to the plurality of hold portions 143 are formed on a plug wall 133 adjacent to the recess wall 142 for placing the plurality of hold portions 143. Wherein, a groove 146 thinner than other portions is formed on a portion of the hold portion 143 near the recess bottom 141. Furthermore, in each of the recesses 134 of the plug wall 133, a plug groove 135 complementary to the groove 146 is formed so that when the attachable/detachable plug 13 is pressed into the recess portion 14, the plug groove 135 is allowed to be rotated in a horizontal direction and pushed into the groove 146 for being fixed within the recess portion 14 of the power supply body 12.

Refer to FIG. 3, which illustrates a power adapter module with an alternative plug. The attachable/detachable plug 13 of the power adapter module 1 is allowed to be rotated in a reverse direction of the above-mentioned horizontal direction for moving the plurality of plug grooves 135 away from the grooves 146, so as to disconnect the plug 13 from the recess portion 14. The horizontal rotating direction might be either clockwise or anti-clockwise. Furthermore, it is not necessary to limit the shape of the recess portion 14. As long as the recess portion 14 may receive and hold the plug base 131, the recess portion 14 may be formed as a semi-circle, a circle, an ellipse, a polygon, or any other desired shapes, and such variations are all within the scope of the present invention. Wherein the preferred embodiments for the recess portions are based on shapes selected from a group including circle, square, curved-surfaced, and polygon.

Refer to FIG. 4, which illustrates a power adapter module with an alternative plug. The power adapter module 1 of the above-mentioned embodiment is further disclosed in this drawing. Wherein, a height a of the groove 146 is lower than the height A of the plug groove. The groove 146 includes an opening side having a stair-like shape. The cross section of the groove is L-shaped. Furthermore, the groove 146 has a thickness thinner than half of the thickness of the hold portion 143. Please further refer to FIGS. 5A and 5B, which are a vertical view and an upward view of a power adapter module with an alternative plug according to the present invention. The plug groove 135 has a thickness thinner than or equal to half the thickness of the hold portion (not shown). Meanwhile, a blocker 136 is further formed on a portion of the plug groove 135 near one end of the hold portion (not shown). The power adapter module 1 further includes a pair of parallel slides 137 formed on the plug base 131, and a circuit connector 138 formed between the parallel slides 137.

Refer to FIG. 6, which illustrates a second preferred embodiment of the present invention. The drawing illustrates a power supply with an alternative plug. As shown in the drawing, the power supply 2 includes a power adapter module 1 with an alternative plug. Wherein, the power adapter module 1 includes a power supply body 12 constructed by putting together an upper housing 10 and a lower housing 11; a rectification/transformation circuit (not shown) installed within the power supply body 12; and an attachable/detachable plug 13. A recess portion 14 is formed within the upper housing 10 for receiving and fixing a plug base 131 of the attachable/detachable plug 13, and a portion of the circuit extends into the recess portion 14 for being electrically connected to a terminal 132 (not shown) of the attachable/detachable plug 13 fixed on the plug base 131. It is characterized in that the recess portion 14 includes a recess bottom 141 and a recess wall 142, wherein a plurality of projecting hold portions 143 are formed on a portion of the recess wall 142 facing a center axial of the recess portion 14, and a plurality of recesses 134 corresponding to the plurality of hold portions 143 are formed on a plug wall 133 adjacent to the recess wall 142 for placing the plurality of hold portions 143. Wherein, a groove 146 thinner than other portions is formed on a portion of the hold portion 143 near the recess bottom 141. Furthermore, in each of the recesses 134 of the plug wall 133, a plug groove 135 complementary to the groove 146 is formed. Accordingly, when the attachable/detachable plug 13 is pressed into the recess portion 14, the plug groove 135 is allowed to be rotated in a horizontal direction and pushed into the groove 146 for being fixed within the recess portion 14 of the power supply body 12.

Further refer to FIGS. 7 and 8, which illustrate various attachable/detachable plugs. In the embodiment, for matching with different receptacle standards in different countries, the attachable/detachable plug 13 could be a plug with flat blades, a plug with flat blades and round grounding pin, a plug with obliquely disposed flat blades, a plug with round pins, a plug with round pins and male grounding pin, a plug with rectangular blades, and a plug with round pins and round grounding pin, and plugs with any other types are all in the equivalent scope of the plug 13 of the embodiment.

In this embodiment, the plug 13, the plug base 131, the plug groove 135, the parallel slides 137, the circuit connector 138, the recess portion 14, the height of groove a, the height of plug groove A, the hold portion 143, and the groove 146 have features and connecting relationships as described in the above-mentioned first embodiment, and will not be repeated here.

FIG. 9 illustrates the applications of the power adapter module described in the above-mentioned embodiments in various portable electric apparatuses. The portable electric apparatuses might be any device having a power adapter module e.g. a digital multi-media broadcasting device, an electronic game console, an electronic storage and display medium, a mobile communication equipment, a mobile GPS, a mobile karaoke system, an image phone, a hand-held data processor, a transformer, an Asymmetric Digital Subscriber Line (ADSL) modem, a router, and a home electric appliance, a travel power adapter, etc. . . The relationship between each of all the portable electric devices and the power adapter module of the present invention can be expressed by the illustrating structure shown in FIG. 9.

Refer to FIG. 9, which illustrates a third preferred embodiment of the present invention. FIG. 9, taking an example of a wireless communication device, illustrates a power adapter module of the present invention mounted to a portable electric device such as an Asymmetric Digital Subscriber Line (ADSL) modem. As shown in the drawing, the ADSL modem 3 includes a casing 31, a Printed Circuit Board (PCB, not shown), and a power adapter module 1 with an alternative plug. Wherein, the power adapter module 1 includes a power supply body 12 constructed by putting together an upper housing 10 and a lower housing 11; a rectification/transformation circuit (not shown) installed within the power supply body 12; and an attachable/detachable plug 13. A recess portion 14 is formed within the upper housing 10 for receiving and fixing a plug base 131 of the attachable/detachable plug, and a portion of the circuit extends into the access portion 14 for being electrically connected to a terminal 132 (not shown) of the attachable/detachable plug 13 fixed on the plug base 131. It is characterized in that the recess portion 14 includes a recess bottom 141 and a recess wall 142, wherein a plurality of projecting hold portions 143 are formed on a portion of the recess wall 142 facing a center axial of the recess portion 14, and a plurality of recesses 134 corresponding to the plurality of hold portions 143 are formed on a plug wall 133 adjacent to the recess wall 142 for placing the plurality of hold portions 143. Wherein, a groove 146 thinner than other portions is formed on a portion of the hold portion 143 near the recess bottom 141. Furthermore, in each of the recesses 134 of the plug wall 133, a plug groove 135 complementary to the groove 146 is formed. Accordingly, when the attachable/detachable plug 13 is pressed into the recess portion 14, the plug groove 135 is allowed to be rotated in a horizontal direction and pushed into the groove 146 for being fixed within the recess portion 14 of the power supply body 12.

In this embodiment, the plug 13, the plug base 131, the plug groove 135, the parallel slides 137, the circuit connector 138, the recess portion 14, the height of groove a, the height of plug groove A, the hold portion 143, and the groove 146 have features and connecting relationships as described in the above-mentioned first and second embodiments, and will not be repeated here.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

### BRIEF DESCRIPTIONS OF DRAWINGS

FIG. 1 is an exploded view illustrating a power adapter module with an alternative plug according to an embodiment of the present invention.

FIG. 2 is an exploded view illustrating a power adapter module with an alternative plug according to an embodiment of the present invention.

FIG. 3 is a perspective view schematically illustrating a power adapter module with an alternative plug according to an embodiment of the present invention.

FIG. 4 is a perspective view schematically illustrating a power adapter module with an alternative plug according to an embodiment of the present invention.

FIG. 5A is a vertical view schematically illustrating an alternative plug according to an embodiment of the present invention.

FIG. 5B is an upward view schematically illustrating an alternative plug according to an embodiment of the present invention.

FIG. 6 is a perspective view schematically illustrating a power supply with an alternative plug according to an embodiment of the present invention.

FIG. 7 is a perspective view schematically illustrating various alternative plugs according to the present invention.

FIG. 8 is a perspective view schematically illustrating various alternative plugs according to the present invention.

FIG. 9 is a perspective view illustrating a power adapter module according to the present invention mounted to a portable electric device.

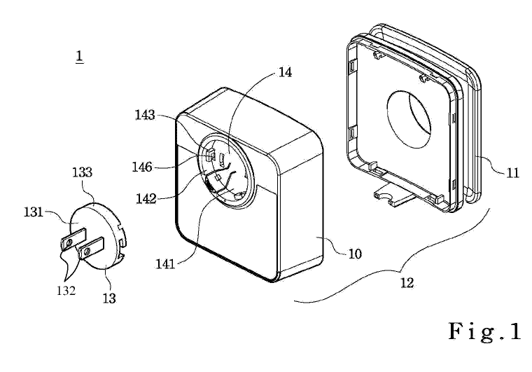

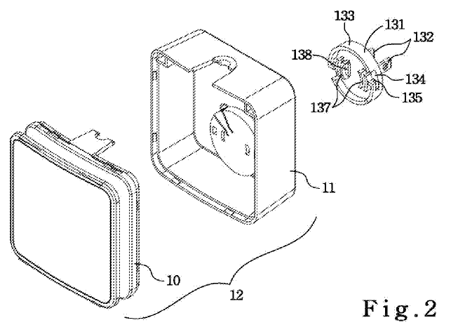

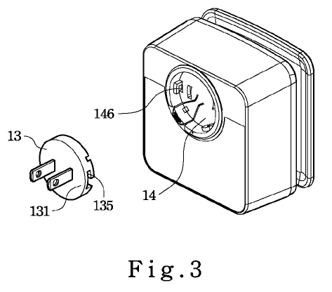

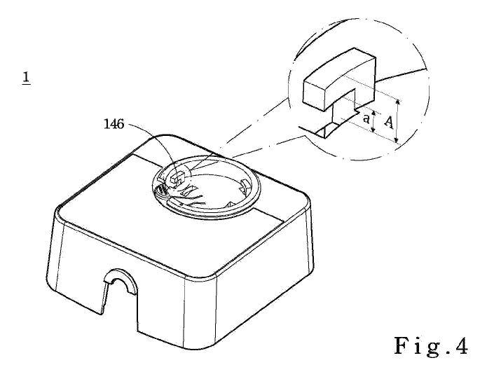

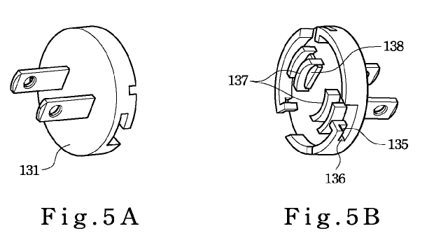

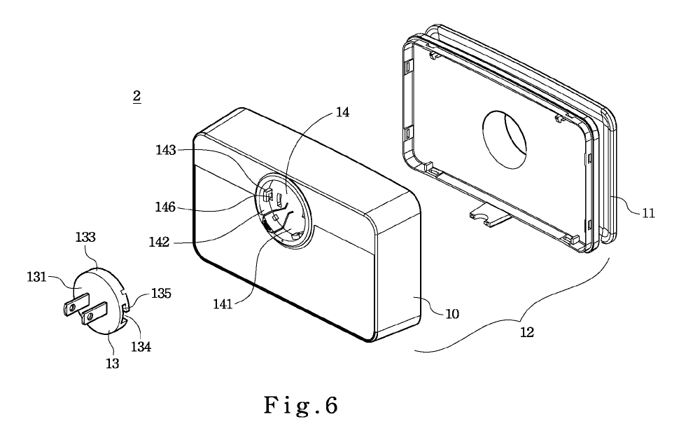

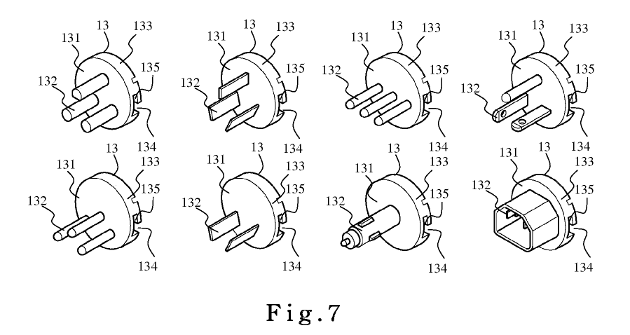

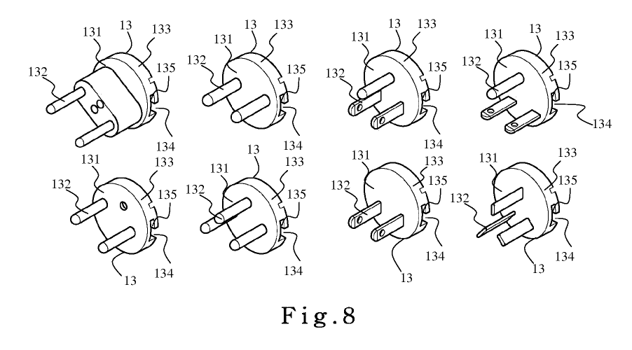

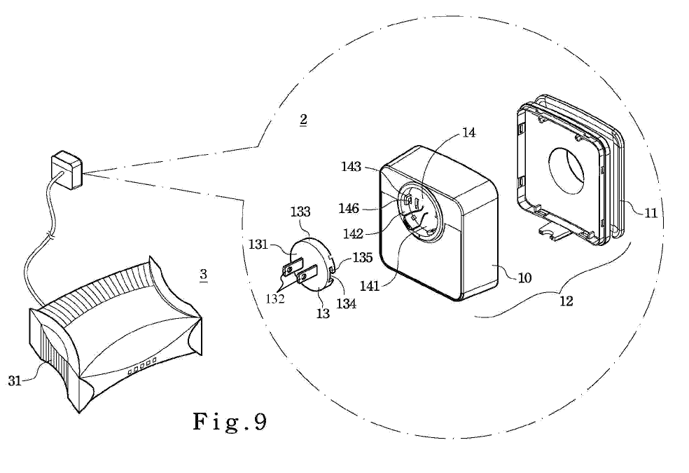

1. A power adapter module with alternative plug, comprising:
a power supply body constructed by putting together an upper housing and a lower housing; and
an attachable/detachable plug, wherein a recess portion is formed within said upper housing for receiving and fixing a plug base of said attachable/detachable plug; said power adapter module is characterized in that:
said recess portion includes a recess bottom and a recess wall, wherein a plurality of projecting hold portions are formed on a portion of said recess wall facing a center axial of said recess portion, and a plurality of recesses corresponding to said plurality of hold portions are formed on a plug wall of said plug adjacent to said recess wall for placing said plurality of hold portions, wherein a groove having a thickness not larger than half the thickness of said hold portion is formed thereon near said recess bottom, and in each of said recesses of said plug wall, a plug groove complementary to said groove is formed so that when said attachable/detachable plug is pressed into said recess portion, said plug groove is allowed to be rotated in a plane parallel to the recess bottom and pushed into said groove for being fixed within said recess portion of said power supply body.

2. A power adapter module according to claim 1, wherein said attachable/detachable plug of said power adapter module is allowed to be rotated reversely in said plane parallel to the recess bottom for moving said plug grooves away from said grooves to disconnect said plug and said recess portion.

3. A power adapter module according to claim 1, wherein said plug groove is allowed to be rotated clockwise in a plane parallel to the recess bottom and pushed into said groove for being fixed within said recess portion of said power supply body.

4. A power adapter module according to claim 1, wherein said plug groove is allowed to be rotated counter-clockwise in a plane parallel to the recess bottom and pushed into said groove for being fixed within said recess portion of said power supply body.

5. A power adapter module according to claim 1, wherein the shape of said recess portion is selected from a circle, a square, a curved surface, and a polygon.

6. (canceled)

7. A power adapter module according to claim 1, wherein said groove includes an opening side having a stair-like shape.

8. A power adapter module according to claim 1, wherein said groove includes an L-shaped cross section.

9. A power adapter module according to claim 1, wherein said groove has a thickness thinner than half a thickness of said hold portion.

10. A power adapter module according to claim 1, wherein said groove has a thickness equal to half a thickness of said hold portion.

11. A power adapter module according to claim 1, wherein said plug groove has a thickness thinner than half a thickness of said hold portion.

12. A power adapter module according to claim 1, wherein said plug groove has a thickness equal to half a thickness of said hold portion.

13. A power adapter module according to claim 1, wherein a blocker is further formed on a portion of said plug groove near one end of said hold portion.

14. A power adapter module according to claim 1, wherein said power adapter module further includes a pair of parallel slides formed on said plug base, and a circuit connector formed

15. A power supply with alternative plug, comprising:
a power supply body constructed by putting together an upper housing and a lower housing; and
an attachable/detachable plug, wherein:
a recess portion is formed within said upper housing for receiving and fixing a plug base of said attachable/detachable plug; said power supply is characterized in that:
said recess portion includes a recess bottom and a recess wall, and a plurality of projecting hold portions are formed on a portion of said recess wall facing a center axial of said recess portion, and a plurality of recesses corresponding to said plurality of hold portions are formed on a plug wall of said plug adjacent to said recess wall for placing said plurality of hold portions, wherein a groove having a thickness not larger than half of the thickness of said hold portion is formed thereon near said recess bottom, and, in each of said recesses of said plug wall, a plug groove complementary to said groove is formed, so that when said attachable/detachable plug is pressed into said recess portion, said plug groove is allowed to be rotated in a horizontal direction and pushed into said groove for being fixed within said recess portion of said power supply body.

16. A portable electric device including at least a power adapter module having an alternative plug, wherein said power adapter module includes a power supply body constructed by putting together an upper housing and a lower housing; a rectification/transformation circuit installed within said power supply body; and an attachable/detachable plug, wherein a recess portion is formed within said upper housing for receiving and fixing a plug base of said attachable/detachable plug, and a portion of said rectification/transformation circuit extends into said recess portion for being electrically connected to a terminal of said attachable/detachable plug fixed on said plug base; said portable electric device is characterized in that:
said recess portion includes a recess bottom and a recess wall, wherein a plurality of projecting hold portions are formed on a portion of said recess wall facing a center axial of said recess portion, and a plurality of recesses corresponding to said plurality of hold portions are formed on a plug wall of said plug adjacent to said recess wall for placing said plurality of hold portions, wherein a groove having a thickness not larger than half of the thickness of said hold portion is thereon near said recess bottom, and, in each of said recesses of said plug wall, a plug groove complementary to said groove is formed, so that when said attachable/detachable plug is pressed into said recess portion, said plug groove is allowed to be rotated in a plane parallel to the recess bottom and pushed into said groove for being fixed within said recess portion of said power supply body.
